(19) United States
(12) Patent Application Publication
(10) Pub. No.: US 2011/0225053 A1
(43) Pub. Date: Sep. 15, 2011

(54) METHOD AND SYSTEM FOR IMPLEMENTING MOBILE CODE ADVERTISEMENTS

(76) Inventor: Robert T. Durst, Dunstable, MA (US)

(21) Appl. No.: 13/043,630

(22) Filed: Mar. 9, 2011

Related U.S. Application Data
(60) Provisional application No. 61/312,653, filed on Mar. 10, 2010.

(51) Int. Cl. G06Q 30/00

(52) U.S. Cl. 705/14.73

(57) ABSTRACT

Advertising with machine-readable (mobile) codes by printing a machine-readable code on a print publication, which is then scanned with a device, and the URL of an ad management computer and an ad identification number are decoded from the mobile code. This URL is used to send the ad identification number to the ad management computer, which accesses a database to determine if a link limit for that ad identification number has been exceeded. If not exceeded, then a destination URL of an advertisement web page associated with the ad identification number in the database is sent to the device so it can connect to that URL. If the link limit has been exceeded, then the destination URL from the database is not sent, but is used as an argument to generate search web page, and the ad content management computer transmits the generated search web page to the device.

### CROSS-REFERENCE TO RELATED APPLICATIONS

This application claims the benefit of U.S. provisional application No. 61/312,653 filed Mar. 10, 2010.

### TECHNICAL FIELD

This invention relates to machine readable codes such as two-dimensional bar codes, and in particular to the use of such codes in a mobile advertising environment for selectively linking a mobile device to Internet content.

### BACKGROUND ART

Currently, machine-readable codes (also referred to herein as mobile codes) exist that are encoded with a URL that when imaged by a mobile device such as an IPHONE will link the mobile device to the web page of that URL. This is referred to as a “direct encode” methodology since the target URL is encoded directly into the mobile code. For example, a service known as GOOGLE PLACES provides a mobile code on a window decal, which is encoded with a URL to a web page controlled and served by GOOGLE. In this system, a café owner may obtain a decal with the mobile code that has a URL encoded therein that links to a GOOGLE page with various information about that café. This enables GOOGLE to control the content and mediate service of that web page to an interested user.

It is desired however to enable the user that scans the mobile code to link to a web page served by and controlled by the café (in this example). That web page may be a menu, an ad, etc. It is also desired to be able to track, mediate, and control the number of links to that web page by users scanning the mobile code with their mobile devices.

### SUMMARY OF THE INVENTION

The present invention is a method of and system for advertising with mobile codes. A campaign manager computer provides to a code producer computer (i) a destination URL that designates the location on a global computer network (such as the Internet) of an advertisement web page of a customer, and (ii) a link limit that designates the number of links to the destination URL for which the customer will pay in a specified time period. The code producer computer sends a request to an ad content management computer to associate an ad identification number with the destination URL and the link limit. The ad content management computer (i) stores in a database the ad identification number with the destination URL and the link limit, and (ii) transmits the ad identification number to the code producer computer. The code producer computer encodes into a mobile code (i) an ad management server URL and (ii) the ad identification number transmitted from the ad content management computer. The code producer computer transmits the mobile code to the campaign manager computer. The mobile code is then printed in association with a print publication.

A user may then scan the mobile code from the print publication using a mobile device. The mobile code is decoded on the mobile device to obtain the ad management server URL and the ad identification number. The mobile device loads the ad management server URL and the ad identification number into a browser and sends the ad management server URL and the ad identification number to the ad content management computer. The ad content management computer accesses the database with the ad identification number to retrieve the associated destination URL, link limit and a current link count. The ad content management computer determines if the current link count exceeds the link limit. If the ad content management computer determines that the current link count does not exceed the link limit, then the ad content management computer (i) transmits the destination URL to the mobile device, and (ii) increments the current link count in the database by one. The mobile device then uses the destination URL received from the ad content management computer to access the advertisement web page of the customer from the customer's content server on the Internet.

If the ad content management computer determines that the current link count exceeds the link limit, then the ad content management computer (i) provides the destination URL to an associated index server, and (ii) increments the current link count in the database by one. The index server generates a search web page using the destination URL as an argument, and the ad content management computer transmits the generated search web page to the mobile device.

As a result, the mobile device will retrieve either (i) the advertisement web page of the customer designated by the destination URL (if the link limit has not been exceeded), or (ii) a search web page generated using the destination URL as an argument for the search (if the link limit has been exceeded).

### BRIEF DESCRIPTION OF THE DRAWING

FIG. 1 is a block diagram of the system of a preferred embodiment; and

FIGS. 2 and 3 are flowcharts of the processes implemented in the preferred embodiment.

### DETAILED DESCRIPTION OF THE PREFERRED EMBODIMENT

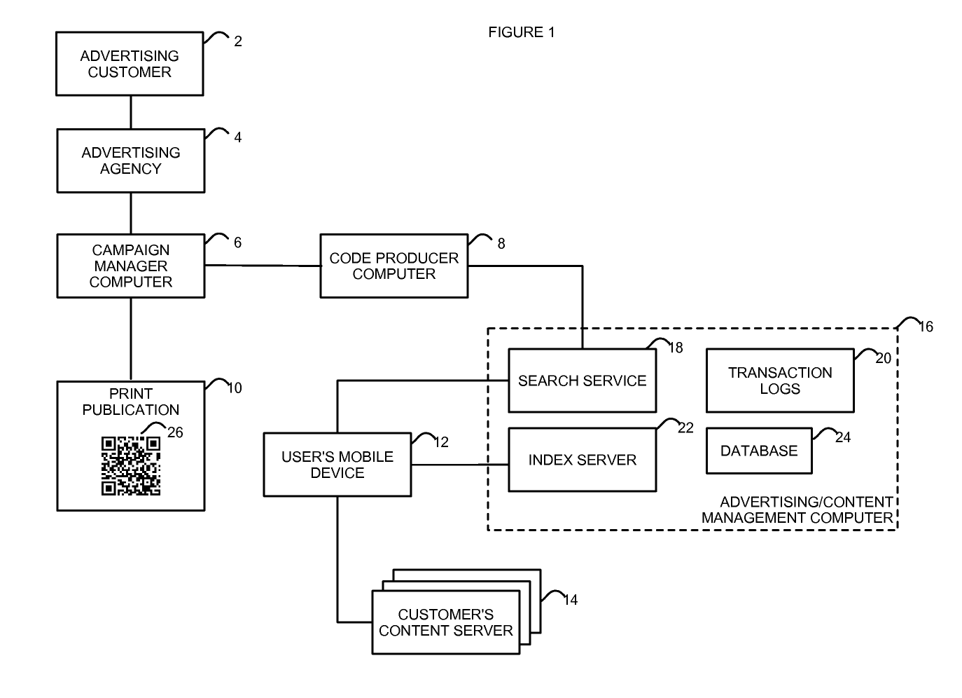

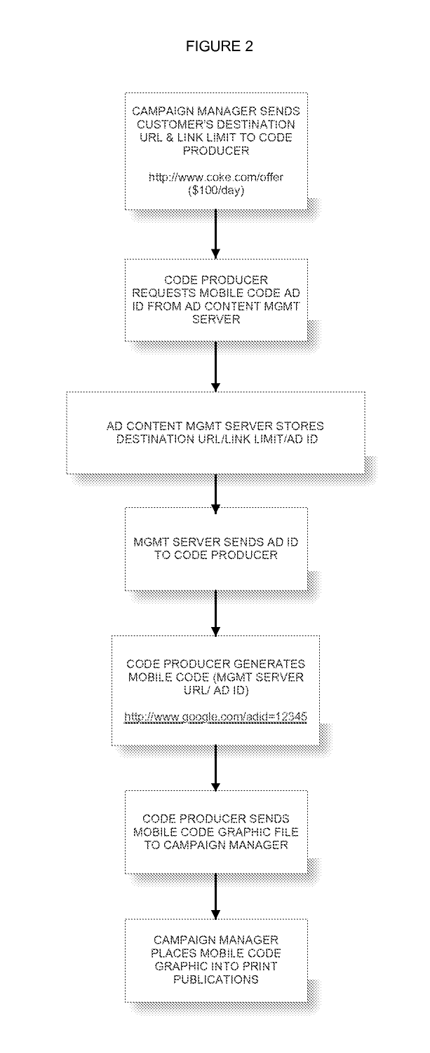

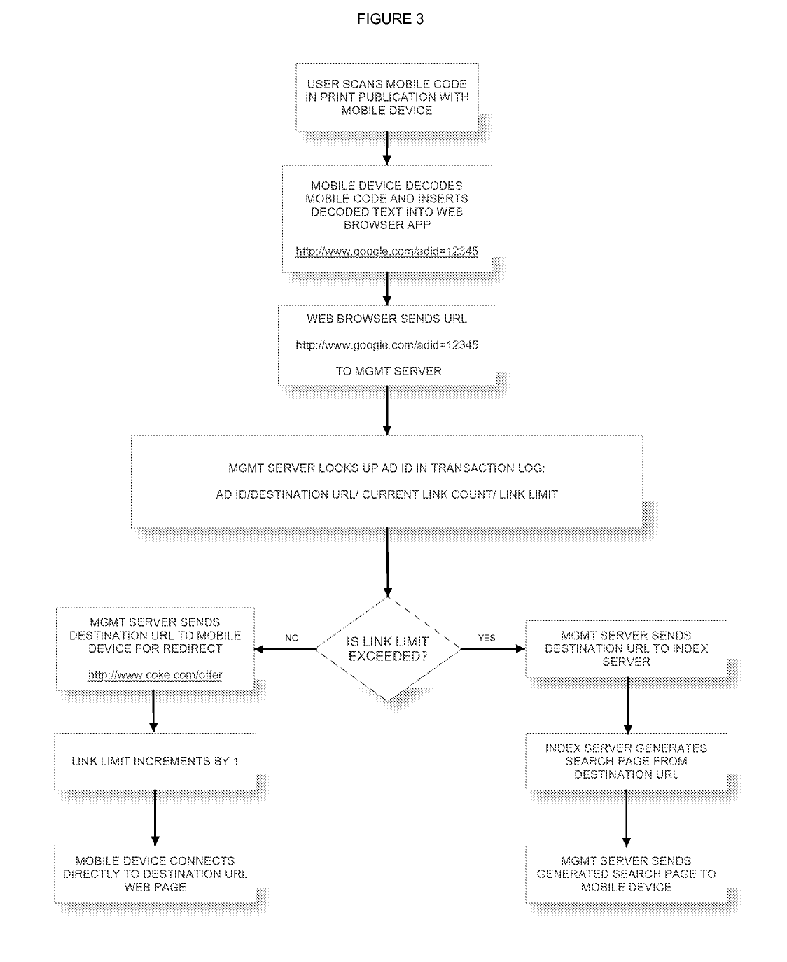

The present invention is a method of and system for advertising with machine-readable codes, also referred to herein as mobile codes. Referring to the block diagram of FIG. 1 and the flowcharts of FIGS. 2 and 3, an advertising customer 2 such as COKE desires to place mobile codes 26 into print publications 10 that, when scanned by a user with a mobile device 12, will connect the mobile device 12 over the Internet to a desired advertisement web page at a destination URL of a content server 14 such as http://www.coke.com/offer. The advertising customer 2, working with an advertising campaign manager directly or in association with an ad agency 4, provides this destination URL along with a budgeted link limit that designates the number of links to the destination URL for which the customer will pay in a specified time period. For example, the customer may be willing to pay for $100 worth of links through this mobile code 26 per day. The link limit may be expressed in the number of links (e.g. 10,000 links if each link costs one penny) or a dollar value (e.g. $100).

Both the destination URL and the link limit are transmitted via a campaign manager computer 6 to a code producer computer 8. The code producer is an entity that manages the production of the mobile codes 26 and interacts with an ad content management system 16. The code producer computer 8 sends a request to the ad content management computer 16 to associate an ad identification number with the destination URL and the link limit that were provided from the campaign manager computer 6. The ad identification number may be generated anew for each request, or an existing one may be reused for existing customers if desired.

The ad content management computer 16 will receive this request from the code producer computer 8 and will associate an ad identification number with the request. Then the ad content management computer 16 will store the ad identification number with the destination URL and the link limit in a database 24. For example, the database 24 may have the following format:

| | | | Current link |
|---|---|---|---|
| Ad ID | Destination URL | Link limit | count |
| 12345 | http://www.coke.com/offer | 10,000/day | 7,879 |
| 67887 | http://www.cafe.com/menu | 500/day | 510 |

As shown above, a field is also stored for the current link count. This may be reset periodically based on the customer's link limit. For example, a daily link limit will cause the current link count to reset at the end of the day. A monthly link limit would cause the current link count to reset at the end of the month, etc.

The ad content management computer 16 will transmit the ad identification number back to the code producer computer 8.

The code producer computer 8 then encodes and generates a mobile code 26 using (i) an ad management server URL provided by the ad content management computer 16 and (ii) the ad identification number transmitted from the ad content management computer 16. So, for example, if the ad management server URL is www.mobilecodeads.google.com, then the mobile code 26 will be encoded with the following URL:

http://www.mobilecodeads.google.com/adid=12345

The code producer computer 8 then transmits the mobile code 26 to the campaign manager computer 6. The campaign manager may then use this mobile code 26 along with various print publications 10 to generate an advertisement that includes typical ad content along with the mobile code graphic.

The mobile code 26 may be any code suitable for being encoded with the URL above and for being easily decoded by a mobile device 12 using commercially available software such as NEOREADER, including but not limited to a QR code as known in the art.

The print publications 10 are disseminated into the public, and a user may then scan the mobile code 26 from the print publication 10 using a mobile device 12 such as an IPHONE mobile device using a software program such as NEOREADER or the like. The mobile code 26 is imaged by the camera device on the mobile device 12 as known in the art and then decoded on the mobile device 12 by the decoding software to obtain the ad management server URL and the ad identification number:

http://www.mobilecodeads.google.com/adid=12345

The mobile device 12 loads the ad management server URL and the ad identification number into a browser program and sends the ad management server URL and the ad identification number to the ad content management computer 16 via a wireless Internet connection as known in the art. The ad content management computer 16 receives this URL and accesses the database 24 with the ad identification number to retrieve the associated destination URL, link limit and a current link count. The ad content management computer 16 then determines if the current link count exceeds the link limit. If the current link count does not exceed the link limit, then the ad content management computer 16 transmits the destination URL (www.coke.com/offer) to the mobile device 12, and increments the current link count in the database 24 by one. The mobile device 12 then uses the destination URL received from the ad content management computer 16 to access the advertisement web page of the customer from the content server 14 on the Internet.

If the ad content management computer 16 determines, however, that the current link count exceeds the link limit, then the ad content management computer 16 provides the destination URL to an associated index server 22, and increments the current link count in the database 24 by one. The index server 22 generates a search web page using the destination URL as an argument, and the ad content management computer 16 transmits the generated search web page to the mobile device 12.

Thus, with reference to the database 24 table above, the current link count of 7,879 does not exceed the link limit specified by the COKE customer, and so the www.coke.com/offer destination URL will be returned to the mobile device 12. The current link count field will be increased by one to 7,880. At some point during the specified period (a day in this example), the current link count may exceed the specified link limit. If that happens, then instead of returning the destination URL to the mobile device 12, then a search web page is returned that was generated using the destination URL as an argument for the search.

As a result, the mobile device 12 will retrieve either (i) the advertisement web page of the customer designated by the destination URL (if the link limit has not been exceeded), or (ii) a search web page generated using the destination URL as an argument for the search (if the link limit has been exceeded).

The ad content management computer 16 will log each transaction in a transaction log 20 for accounting purposes. For example, the customer (COKE in this example) may have agreed to pay one penny per link up to a limit of $100 per day. By using the present system and method, the customer can control its costs for the linking service. In addition, since mobile codes 26 are persistent and may generate many more scans than the customer is willing to pay for, the ad content management computer 16 can stop links from being disseminated after the limit has been reached, yet still provide a satisfactory user experience by serving the search web page as an alternative. The ad content management computer 16 continues to track attempted links in the database 24 so it can present this data to the customer in an effort to modify the existing contract if desired.

It is not required that the ad content management computer 16 server a search web page as described. The system may be programmed to server anything desired by the parties involved, including simple web page that states that the link cannot be completed. However, it would likely be desirable to serve something of value (e.g. the search page) so as to promote use of the system generally amongst the public.

What is claimed is:

1. A method of advertising with machine-readable codes comprising:
storing, in a database associated with an ad management server computer, an ad identification number associated with a destination URL and a link limit, the destination URL indicating a resource location for a web page stored on a content server computer, and the link limit designating the number of allowable links to the destination URL in a specified time period;
encoding into a machine-readable code (i) an ad management server URL associated with the ad management server computer, and (ii) the ad identification number;
printing the machine-readable code onto a print publication;
a user scanning the machine-readable code from the print publication using a mobile device;
decoding the machine-readable code on the mobile device to obtain (i) the ad management server URL and (ii) the ad identification number;
the mobile device using the ad management server URL obtained from the machine-readable code to send the ad identification number to the ad management server computer;
the ad content management computer accessing the database with the ad identification number to retrieve the associated destination URL, the associated link limit and an associated current link count;
the ad content management computer determining if the current link count exceeds the link limit;
if the ad content management computer determines that the current link count does not exceed the link limit, then the ad content management computer (i) transmits the destination URL to the mobile device, and (ii) increments the current link count in the database by one; and
the mobile device uses the destination URL received from the ad content management computer to access the web page stored on the content server computer.

2. The method of claim 1 further comprising the steps of:
if the ad content management computer determines that the current link count exceeds the link limit, then the ad content management computer (i) provides the destination URL to an associated index server, and (ii) increments the current link count in the database by one;
the index server generates a search web page using the destination URL as an argument;
the ad content management computer transmits the generated search web page to the mobile device.

3. A method of advertising with machine-readable codes comprising an ad management computer performing the steps of:
storing in a database an ad identification number associated with a destination URL and a link limit, the destination URL indicating a resource location for a web page stored on a content server computer, and the link limit designating the number of allowable links to the destination URL in a specified time period;
receiving from a user device the ad identification number and a request for the destination URL associated with the ad identification number
accessing the database with the ad identification number to retrieve the associated destination URL, the associated link limit and an associated current link count;
determining if the current link count exceeds the link limit;
if the current link count does not exceed the link limit, then transmitting the destination URL to the mobile device and incrementing the current link count in the database.

4. The method of claim 3 further comprising the ad management computer performing the additional steps of:
if the current link count exceeds the link limit, then using at least part of the destination URL to generate a search results web page; and
transmitting the search results web page to the mobile device.

5. The method of claim 4 further comprising the ad management computer performing the additional step of incrementing the current link count in the database if the current link count exceeds the link limit.

6. The method of claim 3 further comprising a mobile device performing the additional steps of
scanning a machine-readable code encoded with the ad management server URL and the ad identification number;
decoding the mobile code to obtain the ad management server URL and the ad identification number;
using the ad management server URL obtained from the machine-readable code to send the ad identification number to the ad management server computer; and
using the destination URL received from the ad content management computer to access the web page stored on the content server computer.

7. An ad management computer programmed to:
store in a database an ad identification number associated with a destination URL and a link limit, the destination URL indicating a resource location for a web page stored on a content server computer, and the link limit designating the number of allowable links to the destination URL in a specified time period;
receive from a user device the ad identification number and a request for the destination URL associated with the ad identification number
access the database with the ad identification number to retrieve the associated destination URL, the associated link limit and an associated current link count;
determine if the current link count exceeds the link limit;
if the current link count does not exceed the link limit, then transmit the destination URL to the mobile device and increment the current link count in the database.

8. The ad management computer of claim 7 further programmed to:
if the current link count exceeds the link limit, then use at least part of the destination URL to generate a search results web page; and
transmit the search results web page to the mobile device.
